(19) United States
(12) Patent Application Publication
(10) Pub. No.: US 2024/0377782 A1
(43) Pub. Date: Nov. 14, 2024

(54) IMAGE FORMING SYSTEM AND IMAGE FORMING METHOD

(71) Applicant: Hiroki SHIBUTA, Kanagawa (JP)

(72) Inventor: Hiroki SHIBUTA, Kanagawa (JP)

(21) Appl. No.: 18/654,277

(22) Filed: May 3, 2024

(30) Foreign Application Priority Data
May 12, 2023 (JP) 2023-079497

(51) Int. Cl. G03G 15/00; B65H 37/06

(52) U.S. Cl. CPC G03G 15/6573; B65H 37/06; G03G 15/6552; G03G 15/6582; B65H 2301/45; G03G 2215/00877

(57) ABSTRACT

An image forming system includes an image forming apparatus configured to print images on a plurality of sheets; a plurality of folding apparatuses configured to perform a folding process on the plurality of sheets; a memory; and a processor coupled to the memory and configured to switch between the plurality of folding apparatuses for each of the plurality of sheets such that the folding process is performed on the plurality of sheets in continuous printing, and eject one or more sheets on which the folding process is performed by each of the plurality of folding apparatuses to a corresponding ejection tray, wherein an order of the images to be printed on the plurality of sheets in the continuous printing is changeable.

### CROSS-REFERENCE TO RELATED APPLICATION

This application is based on and claims priority to Japanese Patent Application No. 2023-079497, filed on May 12, 2023, the entire contents of which are incorporated herein by reference.

### BACKGROUND OF THE INVENTION

### 1. Field of the Invention

The present disclosure relates to an image forming system and an image forming method.

### 2. Description of the Related Art

An image forming system including an image forming apparatus and a plurality of folding apparatuses that perform a folding process on a plurality of sheets on which images are printed by the image forming apparatus is known. In continuous printing, the folding process is performed on the plurality of sheets while switching between the plurality of folding apparatuses for each of the plurality of sheets, and sheets folded by each of the plurality of folding apparatuses are ejected to a corresponding ejection tray.

As such an image forming system, Patent Document 1 describes an image forming apparatus in which two folding apparatuses are arranged side by side in an ejection direction in which sheets are ejected from the image forming apparatus. In continuous printing, odd-numbered sheets are subjected to a folding process by one folding apparatus, among the two folding apparatuses, located on the downstream side in the ejection direction, and even-numbered sheets are subjected to the folding process by the other folding apparatus located on the upstream side in the ejection direction. Therefore, while the one folding apparatus is performing the folding process, the other folding apparatus can also perform the folding process, thereby improving productivity. The sheets folded by the folding apparatuses are ejected to folded sheet storage boxes, which serve as ejection trays, provided below the respective folding apparatuses.

However, in Patent Document 1, a plurality of sheets constituting a printed material are separately ejected to a plurality of ejection trays. Thus, in a case where a plurality of copies of images of a plurality of pages are printed, sorting work of sorting printed materials after a printing operation is completed becomes complicated.

### RELATED-ART DOCUMENTS

### Patent Documents

Patent Document 1: Japanese Unexamined Patent Application Publication No. 2009-173442

### SUMMARY OF THE INVENTION

According to an embodiment of the present disclosure, an image forming system includes an image forming apparatus configured to print images on a plurality of sheets; a plurality of folding apparatuses configured to perform a folding process on the plurality of sheets; a memory; and a processor coupled to the memory and configured to switch between the plurality of folding apparatuses for each of the plurality of sheets such that the folding process is performed on the plurality of sheets in continuous printing, and eject one or more sheets on which the folding process is performed by each of the plurality of folding apparatuses to a corresponding ejection tray, wherein an order of the images to be printed on the plurality of sheets in the continuous printing is changeable.

### BRIEF DESCRIPTION OF THE DRAWINGS

Other objects and further features of the present invention will be apparent from the following detailed description when read in conjunction with the accompanying drawings, in which:

FIG. 1 is a diagram illustrating a system configuration of an image forming system according to an embodiment;

FIG. 2 is a schematic view of a first folding apparatus;

FIGS. 3A to 3F are explanatory diagrams illustrating a sheet overlay operation;

FIGS. 4A to 4D are explanatory diagrams illustrating a typical operation when a Z-folding process is performed;

FIG. 5 is a diagram illustrating an example hardware configuration of an image forming apparatus;

FIG. 6 is a diagram illustrating an example functional configuration of the image forming system;

FIGS. 7A to 7D are explanatory diagrams illustrating an example of sheet conveyance to each folding apparatus during continuous printing;

FIGS. 8A to 8D are explanatory diagrams illustrating sheet conveyance when odd-numbered sheets are folded by a second folding apparatus and even-numbered sheets are folded by a first folding apparatus;

FIG. 9 is a diagram illustrating a problem when sheets folded by each of the folding apparatuses are ejected to a finisher tray of a post-processing apparatus;

FIG. 10 is a control flowchart of a process for changing a printing order;

FIG. 11 is a diagram illustrating a case in which three copies of images of three pages are printed; and

FIG. 12 is a control flowchart of sheet conveyance during a printing process.

### DESCRIPTION OF THE EMBODIMENTS

Embodiments of the present disclosure will be described below with reference to the accompanying drawings. Modifications and changes are easily made to the embodiments within the scope of the claims to make other embodiments by a person skilled in the art, and these modification and changes are included in the scope of the claims. The following description is merely an example, and does not limit the scope of the claims.

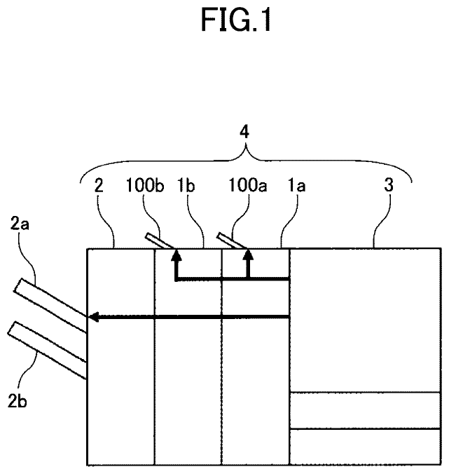

FIG. 1 is a diagram illustrating a system configuration of an image forming system 4 according to an embodiment. In the present embodiment, a first folding apparatus 1a, a second folding apparatus 1b, and a post-processing apparatus 2 are provided downstream of an image forming apparatus 3 in this order.

The image forming apparatus 3 forms an image on a sheet based on input image data or image data of a read image. For example, the image forming apparatus 3 corresponds to a copier, a printer, a facsimile, or a multifunction peripheral having at least two functions of the above machines. The image forming apparatus 3 may use any known image forming method, such as electrophotography or droplet discharge. In the present embodiment, the image forming apparatus 3 is a copier using electrophotography.

Examples of the post-processing apparatus 2 includes a punching apparatus that punches a hole in a sheet, a sheet binding apparatus in which a stapler or the like binds sheets and make a sheet bundle, and a sorter that sorts and ejects sheets, on which images are formed, into a plurality of ejection trays.

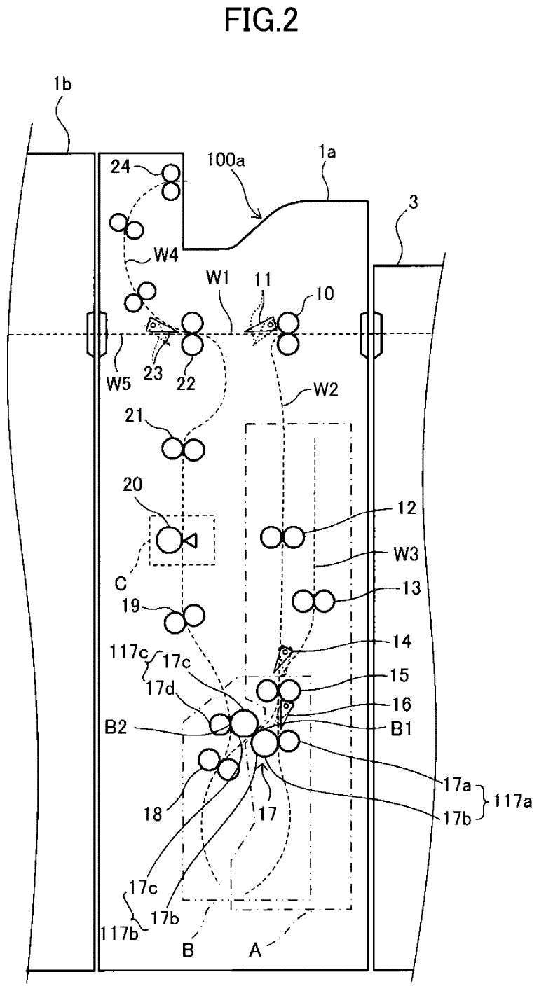

Ejection trays 100a and 100b into which folded sheets are ejected are provided on the upper side of the respective folding apparatuses 1a and 1b. A plurality of finisher trays 2a and 2b, serving as ejection trays, are provided on the left side of the post-processing apparatus 2 in FIG. 2.

FIG. 2 is a schematic view of the first folding apparatus 1a connected to the image forming apparatus 3. The configuration of the second folding apparatus 1b connected to the first folding apparatus 1a is the same as the configuration of the first folding apparatus 1a. The first folding apparatus 1a includes an entry roller pair 10 that conveys a sheet received from the image forming apparatus 3 (the second folding apparatus 1b includes an entry roller pair 10 that conveys a sheet received from the first folding apparatus 1a). On the downstream side of the entry roller pair 10, a sheet conveyance path branches into a folding process conveyance path W2 that conveys a sheet on which a folding process is to be performed and a through conveyance path W1 that conveys a sheet on which the folding process is not performed. A first bifurcating claw 11 is provided at a branch portion between the folding process conveyance path W2 and the through conveyance path W1. The first bifurcating claw 11 guides a sheet to the through conveyance path W1 or the folding process conveyance path W2.

The sheet conveyance path branches into a first ejection path W4 and a second ejection path W5 downstream of an exit roller pair 22 disposed in the vicinity of the downstream side of the position where the through conveyance path W1 and the folding process conveyance path W2 merge. The second ejection path W5 is connected straight to the through conveyance path W1. An ejection bifurcating claw 23 serving as an ejection destination switching unit that guides the sheet to the first ejection path W4 or the second ejection path W5 is provided at a branch portion between the first ejection path W4 and the second ejection path W5.

The first ejection path W4 conveys the sheet to the ejection tray 100a disposed on the upper side of the folding apparatus 1a. The second ejection path W5 conveys the sheet to the second folding apparatus 1b connected to the folding apparatus 1a (the second folding apparatus 1b conveys the sheet to the post-processing apparatus 2).

The folding process conveyance path W2 includes an overlay section A that overlays a plurality of sheets, a folding section B serving as a folding unit that folds one sheet or sheets overlaid in the overlay section A, and an additional folding section C serving as an additional folding unit that additionally folds the folded sheet(s).

The overlay section A includes a registration roller pair 15, a first conveyance roller pair 117a including a first pressing roller 17a and a first folding roller 17b of a folding mechanism 17 described later, and a conveyance roller pair 12 that conveys a sheet toward the registration roller pair 15.

In addition, the overlay section A includes a switchback conveyance path W3. The switchback conveyance path W3 branches from the folding process conveyance path W2 between the conveyance roller pair 12 and the registration roller pair 15. The sheet conveyed in reverse (in a direction opposite to a predetermined direction) by the registration roller pair 15 is conveyed to the switchback conveyance path W3. A switchback conveyance roller pair 13 is disposed in the switchback conveyance path W3.

In addition, the overlay section A includes a second bifurcating claw 14. The second bifurcating claw 14 is disposed at a branch portion between the switchback conveyance path W3 and the folding process conveyance path W2 located between the conveyance roller pair 12 and the registration roller pair 15, and guides the sheet conveyed in reverse (in the direction opposite to the predetermined direction) toward the switchback conveyance path W3.

The folding section B is disposed downstream of the overlay section A. The folding section B includes the above-described registration roller pair 15, the folding mechanism 17, and a second conveyance roller pair 18. The folding mechanism 17 includes the first folding roller 17b and the first pressing roller 17a that contacts the first folding roller 17b and switches back the sheet. Further, the folding mechanism 17 includes a second folding roller 17c that contacts the first folding roller 17b and forms a first folding nip B1, and a second pressing roller 17d that contacts the second folding roller 17c and forms a second folding nip B2. The driving force is transmitted to one of the plurality of rollers included in the folding mechanism 17, and the other rollers are driven to rotate.

Further, a third bifurcating claw 16 is disposed downstream of the registration roller pair 15. The third bifurcating claw 16 guides the sheet to the nip between the first folding roller 17b and the first pressing roller 17a or to the first folding nip B1.

The additional folding section C is disposed downstream of the folding section B. The additional folding section C includes an additional folding roller 20. The additional folding roller 20 has a pressing projection portion, and the pressing projection portion presses the folded portion of the sheet, and the folded portion of the sheet is additionally folded.

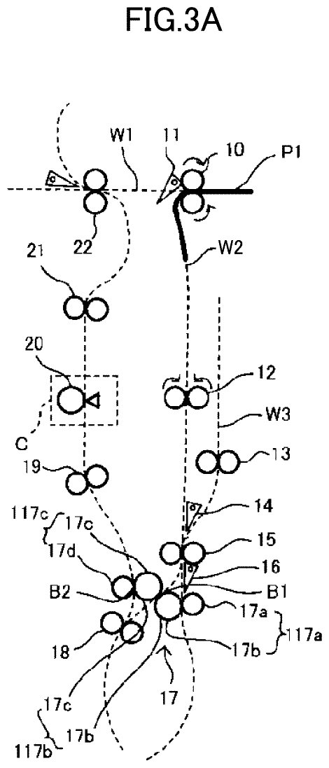

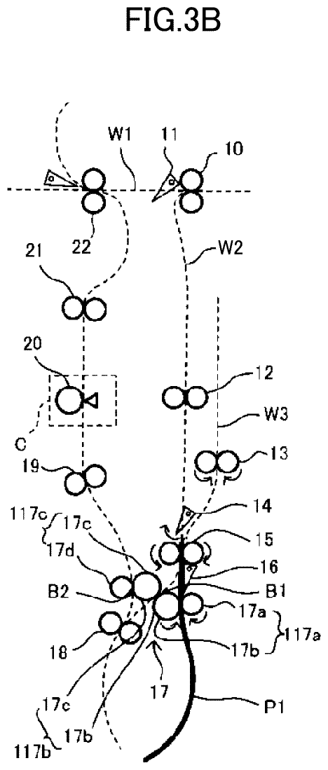

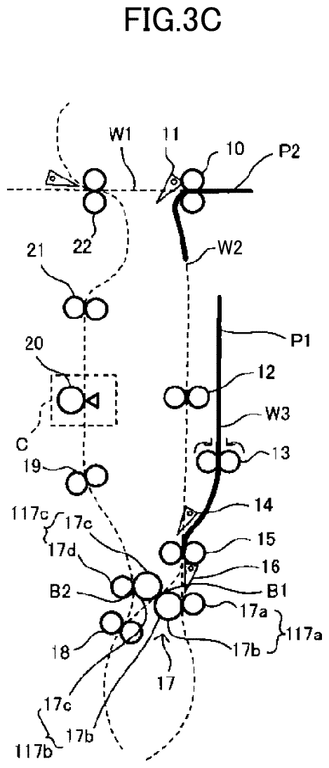

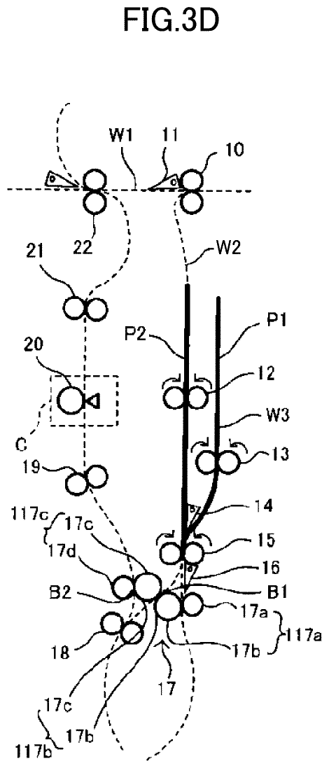

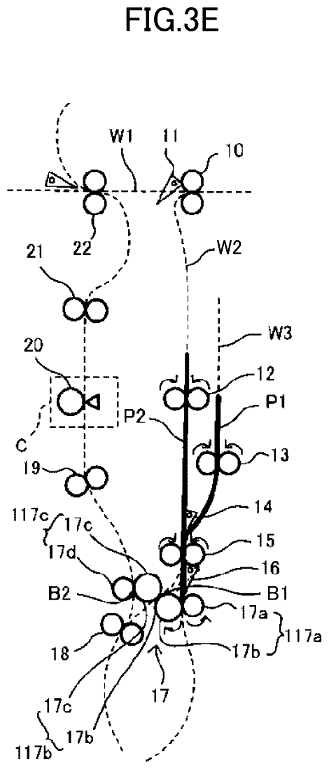

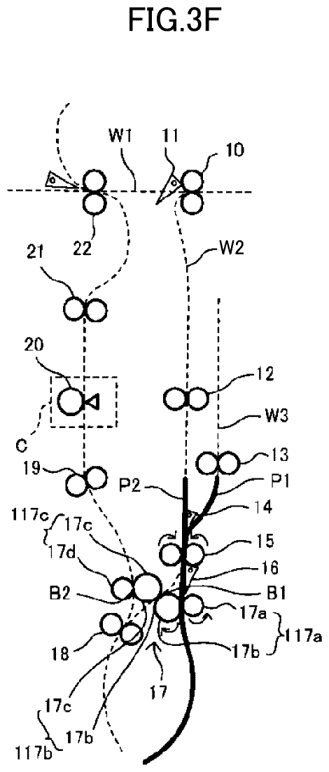

FIGS. 3A to 3F are explanatory diagrams illustrating a sheet overlay operation executed by the overlay section A of the folding apparatus. As illustrated in FIG. 3A, the entry roller pair 10 conveys the first sheet P1 to the folding process conveyance path W2. The leading end of the first sheet P1 conveyed to the folding process conveyance path W2 contacts the registration roller pair 15 to correct skew of the sheet. However, this skew correction is not necessarily performed.

Next, the registration roller pair 15 and the first conveyance roller pair 117a serving as a first conveyance member including the first pressing roller 17a and the first folding roller 17b convey the first sheet P1 forward (in the predetermined direction). Next, when the trailing end of the first sheet P1 has passed through the branch portion between the folding process conveyance path W2 and the switchback conveyance path W3, the conveyance of the first sheet P1 is stopped. Subsequently, the second bifurcating claw 14 is rotated in a clockwise direction, and the orientation of the second bifurcating claw 14 is changed to guide the first sheet P1 to the switchback conveyance path W3.

Next, as illustrated in FIG. 3B, the registration roller pair 15, the first conveyance roller pair 117a, and the switchback conveyance roller pair 13 are rotated in reverse. As a result, the first sheet P1 is conveyed in reverse (in the direction opposite to the predetermined direction), and the first sheet P1 is conveyed to the switchback conveyance path W3. When the leading end of the first sheet P1 during forward conveyance (conveyance in the predetermined direction) is conveyed to the switchback conveyance path W3, the conveyance of the first sheet P1 by the switchback conveyance roller pair 13 is stopped.

After the conveyance of the first sheet P1 is stopped, as illustrated in FIG. 3C, the switchback conveyance roller pair 13 conveys the first sheet P1 forward (in the predetermined direction), causes the leading end of the first sheet P1 to contact the registration roller pair 15, and causes the first sheet P1 to be on standby with skew corrected.

In this manner, the preceding first sheet P1 is conveyed to the switchback conveyance path W3 and is withdrawn from the folding process conveyance path W2. Thus, the preceding first sheet P1 does not obstruct the conveyance of a subsequent second sheet P2, thereby enabling smooth conveyance of the subsequent second sheet P2.

Next, the leading end of the second sheet P2 contacts the registration roller pair 15. As illustrated in FIG. 3D, after the leading end of the subsequent second sheet P2 contacts the registration roller pair 15, the conveyance roller pair 12 continues to convey the subsequent second sheet P2 and bends the subsequent second sheet P2 to correct skew of the second sheet P2.

After a predetermined period of time in which the second sheet P2 is bent by a predetermined amount has passed, as illustrated in FIG. 3E, the registration roller pair 15, the switchback conveyance roller pair 13, and the first conveyance roller pair 117a are rotated. As a result, the first sheet P1 and the second sheet P2 are conveyed in an overlaid manner (FIG. 3F).

If the number of overlaid sheets reaches the number set by a user, the folding section B starts to perform a multi-sheet folding process. Conversely, if the number of overlaid sheets does not reach the number set by the user, the overlaid sheets are conveyed in reverse (in the direction opposite to the predetermined direction) when the trailing ends of the overlaid sheets have passed through the bifurcating claw, and the overlaid sheets are placed in the switchback conveyance path W3. The sheets can be overlaid by repeating the above-described operation according to the number of sheets to be overlaid.

In the present embodiment, as described above, the skew of the subsequent second sheet P2 is corrected without stopping the rotation of the conveyance roller pair 12, and the registration roller pair 15 starts to rotate in response to the bending amount of the subsequent second sheet P2 reaching the predetermined amount. Accordingly, the preceding sheet and the subsequent sheet are overlaid without reducing productivity.

While the number of overlaid sheets does not reach the number set by the user, an overlay process without skew correction by the registration roller pair 15 may be performed. When the number of overlaid sheets reaches the number set by the user, an overlay process with skew correction by the registration roller pair 15 may be performed.

In the overlay process with skew correction, the leading end of a preceding sheet (sheet bundle) contacts the registration roller pair so as to perform skew correction and the preceding sheet (sheet bundle) is put on standby, and then, after a subsequent sheet contacts the registration roller pair so as to perform skew correction, the sheets are overlaid and conveyed. Conversely, in the overlay process without skew correction, the leading end of the preceding sheet (sheet bundle) is put on standby in a state in which the preceding sheet is placed in the switchback conveyance path W3. The switchback conveyance roller pair 13 starts to convey the preceding sheet (sheet bundle) such that the preceding sheet placed in the switchback conveyance path W3 reaches the registration roller pair 15 when the subsequent sheet P2 reaches the registration roller pair 15. Then, the preceding sheet and the subsequent sheet are overlaid, and the registration roller pair 15 conveys the overlaid sheets.

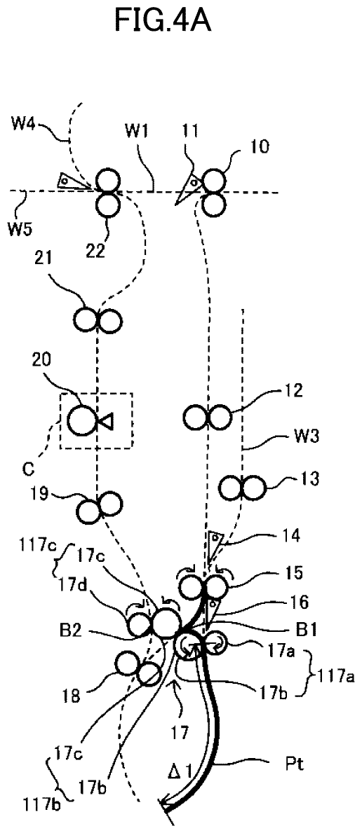

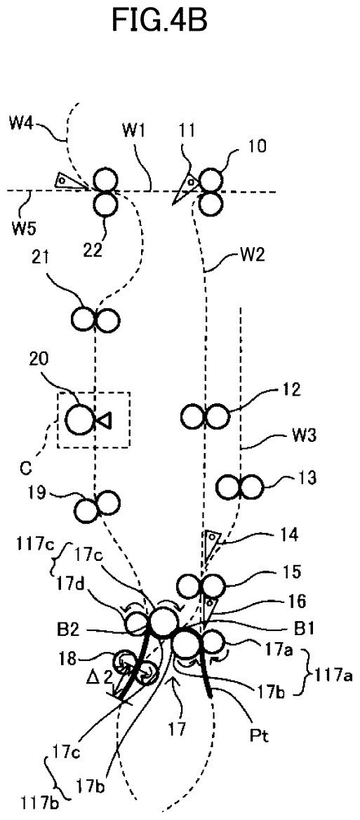

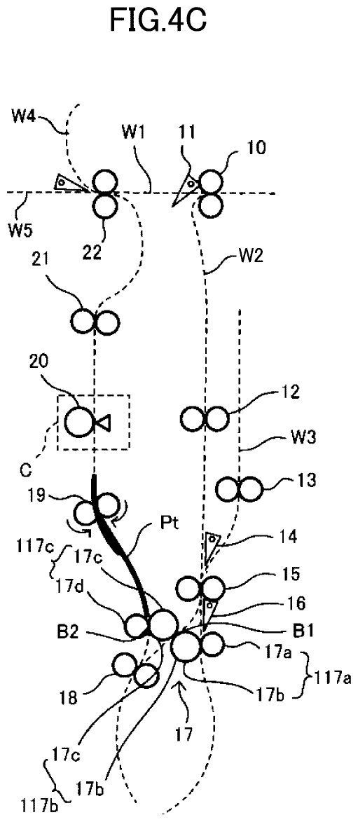

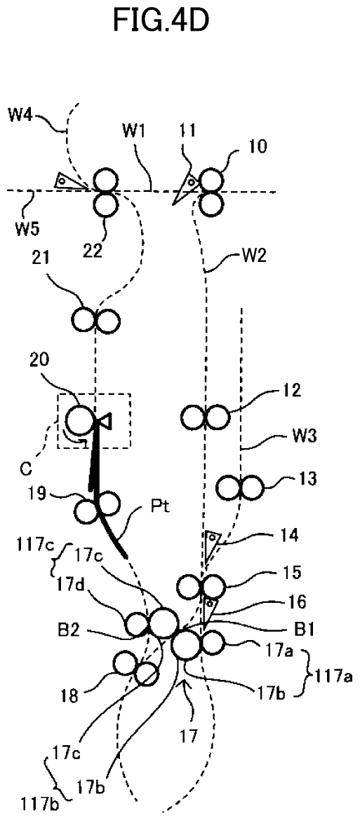

FIGS. 4A to 4D are explanatory diagrams illustrating a typical operation when the folding section B performs a Z-folding process. In the following description, a sheet bundle Pt subjected to the overlay process is folded; however, a folding process for folding one sheet is performed in the same manner. The leading end of the sheet bundle Pt conveyed by the registration roller pair 15 enters the first conveyance roller pair 117a including the first folding roller 17b and the first pressing roller 17a. When the sheet bundle Pt is conveyed by a predetermined conveyance amount 41, a drive motor that drives the folding mechanism 17 is rotated in reverse. The conveyance amount at this time is appropriately determined according to the length of the sheet bundle Pt in the sheet conveyance direction and the content of the folding process (such as a folding method).

The reverse rotation of the drive motor that drives the folding mechanism 17 conveys the sheet bundle Pt sandwiched by the first conveyance roller pair 117a in reverse (in the direction opposite to the predetermined direction). This forms a bend in the sheet bundle portion between registration roller pair 15 and the first conveyance roller pair 117a (FIG. 4A).

This bend portion (folded-back portion) enters a nip of a first folding roller pair 117b including the first folding roller 17b and the second folding roller 17c, thereby forming a first folded portion in the folded-back portion. The first folded portion that has passed through the nip of the first folding roller pair 117b is conveyed toward the second conveyance roller pair 18 serving as a second conveyance member.

Then, the first folded portion of the sheet bundle Pt enters a nip of the second conveyance roller pair 18. When the second conveyance roller pair 18 conveys the sheet bundle Pt by a predetermined conveyance amount 42, the second conveyance roller pair 18 is rotated in reverse and conveys the sheet bundle Pt sandwiched by the second conveyance roller pair 18 in reverse (in the direction opposite to the predetermined direction). The conveyance amount A2 at this time is appropriately determined according to the length of the sheet bundle Pt in the sheet conveyance direction and the content of the folding process (such as a folding method).

The reverse conveyance (in the direction opposite to the predetermined direction) of the sheet bundle Pt sandwiched by the second conveyance roller pair 18 forms a bend in the sheet portion between the first folding roller pair 117b and the second conveyance roller pair 18.

As illustrated in FIG. 4B, this bent portion (folded-back portion) enters a nip of a second folding roller pair 117c serving as a second folding member including the second folding roller 17c and the second pressing roller 17d, thereby forming a second folded portion in the folded-back portion.

As illustrated in FIG. 4C, an intermediate conveyance roller pair 19 conveys the sheet bundle Pt having the two folded portions formed as described above, which has passed through the nip of the second folding roller pair 117c, toward the additional folding roller 20.

As illustrated in FIG. 4D, when the second folded portion reaches the position facing the additional folding roller 20, the conveyance of the sheet bundle Pt is stopped. Subsequently, the additional folding roller 20 is rotated and puts a sharp crease at the second folded portion, and then the conveyance of the sheet bundle Pt is resumed. When the first folded portion reaches the position facing the additional folding roller 20, the conveyance of the sheet bundle Pt is stopped. Subsequently, the additional folding roller 20 is rotated and puts a sharp crease at the first folded portion, and then the conveyance of the sheet bundle Pt is resumed and the sheet bundle Pt is conveyed to the exit roller pair 22.

Note that if additional folding is not performed, for example, if the folding process is performed on one sheet or additional folding is not set by the user, the sheet is continuously conveyed to the exit roller pair 22 without being stopped.

If the folded sheet bundle Pt is conveyed to the post-processing apparatus 2, the folded sheet bundle Pt is conveyed to the second ejection path W5. If the folded sheet bundle Pt is ejected to the ejection tray 100a provided on the upper side of the folding apparatus, the folded sheet bundle Pt is conveyed to the first ejection path W4.

In the above description, the Z-folding process has been described; however, letter fold-in or letter fold-out can be performed by an operation similar to the Z-folding process by appropriately changing the conveyance amount 41 and the conveyance amount 42. In a half-folding process, the third bifurcating claw 16 is rotated in the clockwise direction in FIGS. 4A to 4D such that the third bifurcating claw 16 is oriented to guide the sheet to the first folding roller pair 117b. The sheet conveyed from the registration roller pair 15 is conveyed to the first folding roller pair 117b. Then, a folded portion is formed at the center of the sheet in the sheet conveyance direction by performing an operation similar to the above-described operation for forming the second folded portion. In this manner, the half-folding process can be performed.

FIG. 5 is a diagram illustrating an example hardware configuration of the image forming apparatus 3 according to the present embodiment. As illustrated in FIG. 5, the image forming apparatus 3 includes a controller 1300, a bus 1309, an operation panel 1310, a fax control unit (FCU) 1320, and an engine 1350.

The controller 1300 includes an application-specific integrated circuit (ASIC) 1301, a memory 1302, a hard disk drive (HDD) 1303, a central processing unit (CPU) 1304, a north bridge 1305. Further, the controller 1300 includes, a memory 1306, a south bridge 1307, a bus 1308, a network interface card (NIC) 1311, a universal serial bus (USB) 1312, an IEEE 1394 (1313), Centronics 1314, and a real time clock (RTC) 1323.

The FCU 1320 includes a non-volatile memory (NVM) 1321 and an RTC 1322. The engine 1350 includes a plotter 1201, a scanner 1202, and other hardware resources 1203.

The image forming apparatus 3 includes a hardware configuration in which the operation panel 1310, the FCU 1320, and the engine 1350 are connected to the ASIC 1301 of the controller 1300 via the bus 1309.

The CPU 1304 of the controller 1300 includes a processor and peripheral circuits, and controls the entire image forming system 4. The memory 1306 is a storage device used as a work area when a program executed by the CPU 1304 performs control. The HDD 1303 is an auxiliary storage device that stores programs executed by the CPU 1304 and data to be used. The HDD 1303 may be, for example, a hard disk drive or a storage device configured with a flash memory. The NIC 1311, the USB 1312, the IEEE 1394 (1313), and the Centronics 1314 are various interfaces.

The operation panel 1310 is, for example, a device such as a touch panel in which a display device and an input device are integrated. The input device is a device for a user or an administrator to perform various input operations. A mouse, a keyboard, and the like other than the touch panel may be used for an input operation by the user. Further, the operation panel 1310 displays various kinds of information to the user.

The engine 1350 is hardware that is connected to the controller 1300 via the bus 1309, and is controlled by the controller 1300 to operate the plotter 1201 and the scanner 1202 to perform printing or scanning and eject paper sheets.

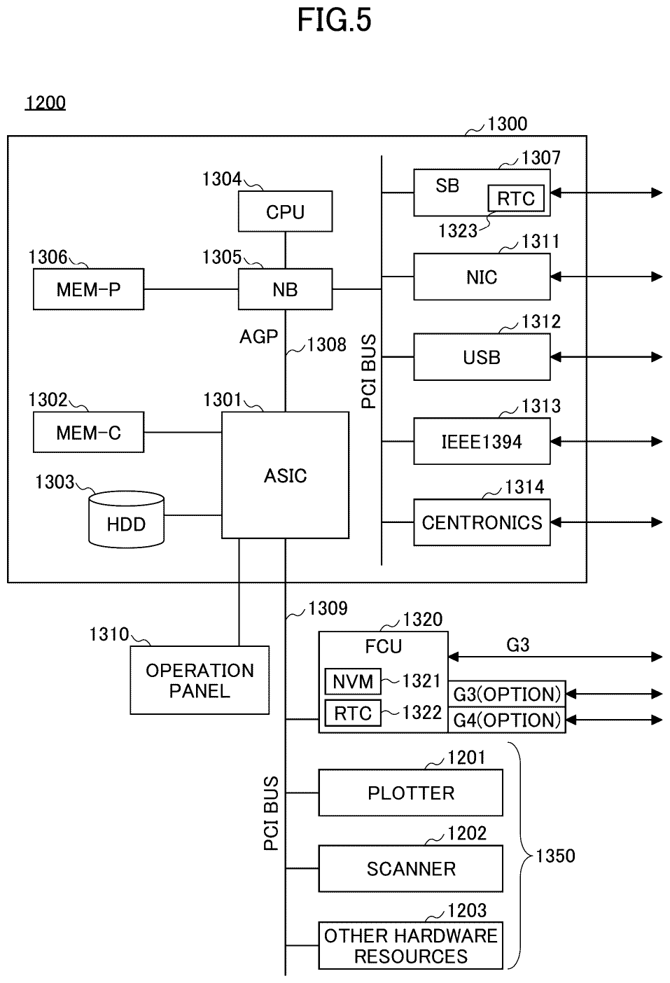

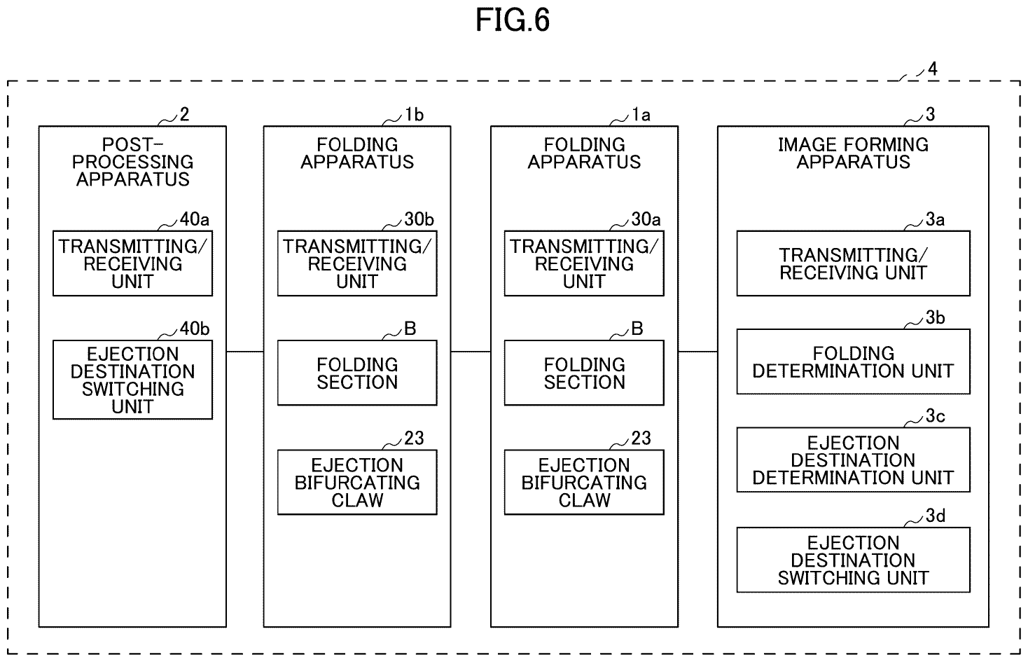

FIG. 6 is a diagram illustrating an example functional configuration of the image forming system 4 according to the present embodiment. The image forming apparatus 3 includes a transmitting/receiving unit 3a, a folding determination unit 3b, an ejection destination determination unit 3c, and an ejection destination switching unit 3d.

The transmitting/receiving unit 3a transmits and receives information, such as the states of the apparatuses, information on whether folding is to be performed, information on the type of folding, information on whether post-processing (punching, binding, or the like) is to be performed, and information on the type of post-processing, to and from the folding apparatuses 1a and 1b and the post-processing apparatus 2. The user can set whether to perform folding, the type of folding, whether post-processing (punching, binding, and the like) is to be performed, and the type of post-processing, and the like by performing an input operation on the input device of the operation panel 1310.

The folding determination unit 3b determines whether folding can be performed based on the states of the folding apparatuses 1a and 1b and the like received by the transmitting/receiving unit 3a. The ejection destination determination unit 3c determines an ejection destination of a sheet on which an image is printed by the image forming apparatus 3. For example, the ejection destination determination unit 3c determines an ejection destination of a sheet on which an image is printed, based on a sheet ejection destination set by the user performing an input operation on the input device of the operation panel 1310.

The folding apparatuses 1a and 1b include transmitting/receiving units 30a and 30b, respectively. The transmitting/receiving units 30a and 30b receive, from the image forming apparatus 3, information such as information whether folding is to be performed, information on the type of folding (multi-sheet fold, single-sheet fold, Z-fold, letter fold-in, letter fold-out, or the like), and information on a determined sheet ejection destination, and transmit the states of the apparatuses to the image forming apparatus 3.

Each of the folding apparatuses 1a and 1b controls the folding section B and the like based on information on the type of folding received from the image forming apparatus 3, and performs a folding process on sheets on which images are printed. Each of the folding apparatuses 1a and 1b controls the ejection bifurcating claw 23 and the first bifurcating claw 11 based on information on whether folding is to be performed and information on a sheet ejection destination received from the image forming apparatus 3. Specifically, if a transmitting/receiving unit of a folding apparatus receives information indicating that folding is not to be performed (folding is not to be performed in this folding apparatus) from the image forming apparatus 3, the folding apparatus controls the first bifurcating claw 11 to convey a sheet on which an image is printed to the through conveyance path W1. Conversely, if the transmitting/receiving unit receives information indicating that folding is to be performed (folding is to be performed in this folding apparatus) from the image forming apparatus 3, the folding apparatus controls the first bifurcating claw 11 to convey the sheet on which the image is printed to the folding process conveyance path W2.

If the sheet ejection destination received from the image forming apparatus 3 is the ejection tray of this folding apparatus, the folding apparatus controls the ejection bifurcating claw 23 to convey the sheet on which the image is formed to the first ejection path W4. Conversely, if the sheet ejection destination received from the image forming apparatus 3 is not the ejection tray of this folding apparatus, the folding apparatus controls the ejection bifurcating claw 23 to convey the sheet to the second ejection path W5.

Further, the folding apparatuses 1a and 1b cause the transmitting/receiving units 30a and 30b to transmit the states of the folding apparatuses (for example, paper jams, the full states of sheets stacked on the ejection tray 100a and 100b, or the like) to the image forming apparatus 3. Based on the received states of the folding apparatuses (for example, paper jams, the full states of sheets stacked on the ejection trays, or the like), the image forming apparatus 3 causes the display device of the operation panel 1310 to display the states of the folding apparatuses (indicating that there are paper jams, the ejection trays are full, or the like), and prompts the user to take a predetermined measure.

The post-processing apparatus 2 includes a transmitting/receiving unit 40a that receives information whether post-processing is to be performed, information on post-processing (for example, information on a punching position or a binding position), information on a determined sheet ejection destination, and the like from the image forming apparatus 3, and transmits the state of the apparatus to the image forming apparatus 3. Further, the post-processing apparatus 2 includes an ejection destination switching unit 40b that switches between the two finisher trays 2a and 2b.

The post-processing apparatus 2 performs predetermined post-processing based on information whether post-processing is to be performed, information on the post-processing (for example, information on a punching position or a binding position), and the like received by the transmitting/receiving unit 40a from the image forming apparatus 3. Further, based on the information on the sheet ejection destination received by the transmitting/receiving unit 40a from the image forming apparatus 3, the post-processing apparatus 2 controls the ejection destination switching unit 40b to eject a sheet to a set finisher tray among the two finisher trays 2a and 2b.

Further, the post-processing apparatus 2 causes the transmitting/receiving unit 40a to transmit the state of the post-processing apparatus 2 (for example, a paper jam, the full state of sheets stacked on any of the finisher trays 2a and 2b, or the like) to the image forming apparatus 3. Based on the state of the post-processing apparatus 2 (for example, a paper jam, the full state of sheets stacked on the finisher tray 2a or 2b, or the like) received from the post-processing apparatus 2, the image forming apparatus 3 causes the display device of the operation panel 1310 to display the state of the post-processing apparatus (indicating that there is a paper jam, the finisher tray 2a or 2b is full, or the like), and prompts the user to take a predetermined measure.

The folding section B of each of the folding apparatuses 1a and 1b according to the present embodiment has an advantage that an increase in the size of each of the folding apparatuses 1a and 1b can be suppressed. However, depending on the type of folding, there may be a case where a sheet is folded after being conveyed in reverse. In such a case, a sheet interval would be increased and productivity would not be sufficient. As illustrated in FIG. 2, from the viewpoint of reducing the size of each of the apparatuses, a portion of the overlay section A is used as a portion of the folding section B. Therefore, during the folding process, a sheet is unable to be conveyed to and temporarily held in the switchback conveyance path W3. This would cause a sheet interval to be increased and productivity to be reduced.

In view of the above, in the present embodiment, in order to improve productivity, the two folding apparatuses 1a and 1b are coupled to each other and, in a case where single-sheet folding is performed on all sheets in continuous printing, a folding apparatus that performs a folding process is switched for each of the sheets. Accordingly, while the first folding apparatus 1a is performing the folding process, a sheet is conveyed to the folding process conveyance path W2 of the second folding apparatus 1b, and the second folding apparatus 1b can also perform the folding process. As a result, an increase in a sheet interval between sheets ejected from the image forming apparatus 3 can be suppressed, and productivity can be improved.

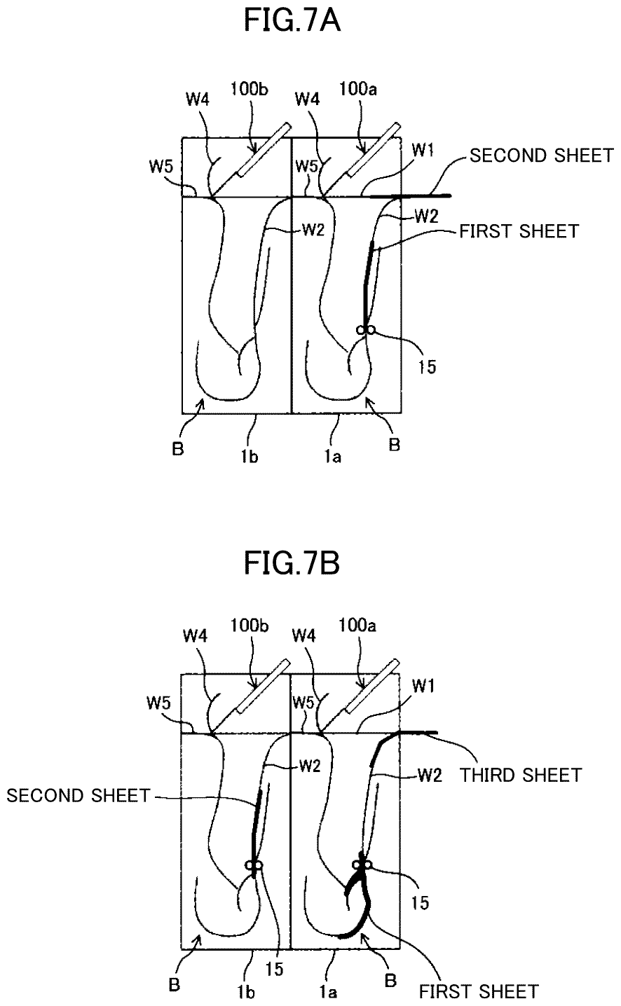

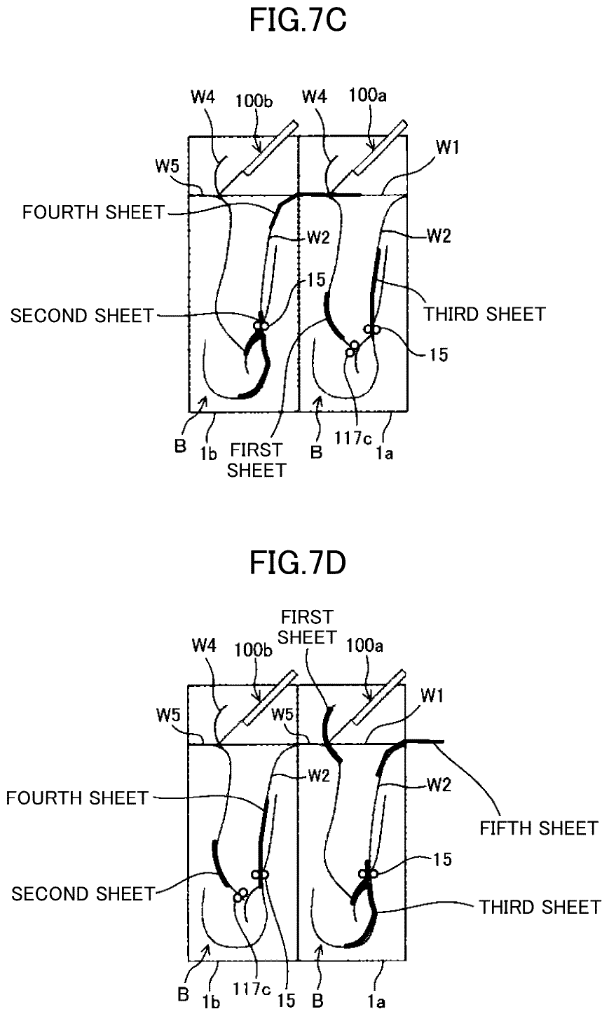

FIGS. 7A to 7D are explanatory diagrams illustrating an example of sheet conveyance to each of the folding apparatuses during continuous printing according to the present embodiment. Sheets are conveyed in order of FIG. 7A-FIG. 7B-FIG. 7C-FIG. 7D. In the present embodiment, in continuous printing, odd-numbered sheets are folded by the first folding apparatus 1a and even-numbered sheets are folded by the second folding apparatus 1b. As illustrated in FIG. 7A, a timing at which the leading end of an even-numbered sheet reaches the branch portion between the folding process conveyance path W2 and the through conveyance path W1 of the first folding apparatus 1a is as follows. That is, the leading end of an even-numbered sheet reaches the branch portion between the folding process conveyance path W2 and the through conveyance path W1 at a timing at which the trailing end of an odd-numbered sheet, conveyed to the folding process conveyance path W2 of the first folding apparatus 1a, passes through the branch portion between the folding process conveyance path W2 and the through conveyance path W1 of the first folding apparatus 1a and causes the first bifurcating claw 11 to oscillate, such that the even-numbered sheet can be guided to the through conveyance path W1.

The leading end of a subsequent sheet reaches the registration roller pair 15 during the next period of time, thereby preventing a jam and suppressing a reduction in productivity. That is, the leading end of the subsequent sheet reaches the registration roller pair 15 during a period of time in which the trailing end of a preceding sheet passes through the registration roller pair 15, the registration roller pair 15 is temporarily stopped, and the trailing end of the preceding sheet passes through the second folding roller pair 117c (the folding section B).

In this example, as illustrated in FIGS. 7B and 7C, the subsequent sheet is conveyed to the folding process conveyance path W2 at a timing at which the preceding sheet is bent (see FIG. 4A), thereby forming a first folded portion. Then, after the preceding sheet passes through the registration roller pair 15 and the registration roller pair 15 is temporarily stopped, the leading end of the subsequent sheet contacts the registration roller pair 15 and skew correction is performed. Then, upon the trailing end of the preceding sheet passing through the second folding roller pair 117c (folding section B), the subsequent sheet is conveyed by the registration roller pair 15 and the folding process is performed on the subsequent sheet (see FIG. 7C for first folding apparatus 1a, and see FIG. 7D for the second folding apparatus 1b).

As illustrated in FIG. 7C, the fourth sheet passes through the branch portion between the first ejection path W4 and the second ejection path W5 of the first folding apparatus 1a immediately after the first sheet passes through the folding section B of the first folding apparatus 1a. Therefore, after the trailing end of the fourth sheet passes through the branch portion between the first ejection path W4 and the second ejection path W5 of the first folding apparatus 1a, the first sheet reaches this branch portion, moves along the first ejection path W4, and is ejected to the ejection tray 100a of the first folding apparatus 1a.

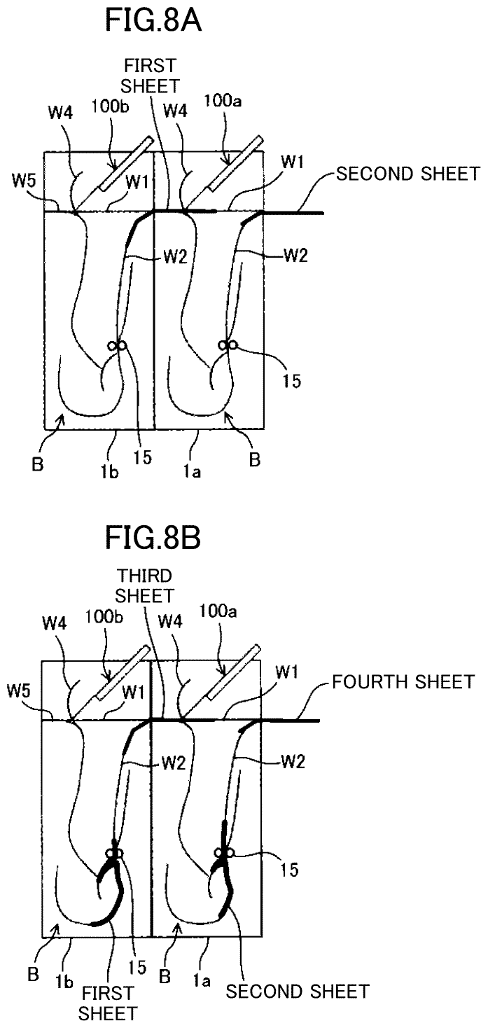

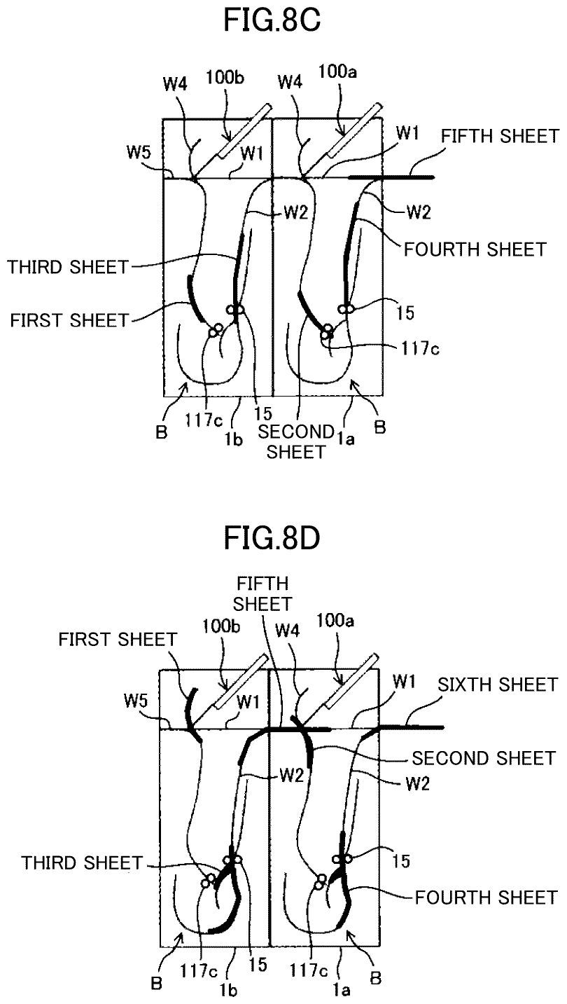

FIGS. 8A to 8D are explanatory diagrams illustrating sheet conveyance when odd-numbered sheets are folded by the second folding apparatus 1b and even-numbered sheets are folded by the first folding apparatus 1a. When odd-numbered sheets are folded by the second folding apparatus 1b and even-numbered sheets are folded by the first folding apparatus 1a, as illustrated in FIG. 8A, sheets are conveyed to the folding process conveyance paths W2 of the first folding apparatus 1a and the second folding apparatus 1b at substantially the same timing. Then, the folding process is performed at substantially the same timing.

If the sheets are conveyed at the timing and the conveying speed as described in FIGS. 7A to 7D in order not to reduce productivity, a state as illustrated in FIG. 8D would occur. That is, before the trailing end of the fifth sheet passes through the branch portion between the first ejection path W4 and the second ejection path W5 of the first folding apparatus 1a, the leading end of the second sheet reaches this branch portion and collides with the fifth sheet. If the sheets collide at the branch portion between the first ejection path W4 and the second ejection path W5 of the first folding apparatus 1a, a jam would occur.

In order to prevent such collision, it is necessary to reduce the conveying speed of a sheet that has passed through the folding section B of the first folding apparatus 1a or delay the timing at which an odd-numbered sheet is conveyed to the folding process conveyance path W2 of the second folding apparatus 1b. As a result, productivity would be reduced.

In contrast, according to the present embodiment, odd-numbered sheets are folded by the first folding apparatus 1a and even-numbered sheets are folded by the second folding apparatus 1b, and thus the following effect can be obtained. That is, as illustrated in FIG. 7D, a sheet to be folded by the second folding apparatus 1b and a sheet folded by the first folding apparatus 1a do not collide with each other at the branch portion between the first ejection path W4 and the second ejection path W5 of the first folding apparatus 1a. Therefore, it is not necessary to reduce the conveying speed of the sheet that has passed through the folding section B of the first folding apparatus 1a or delay the timing at which the sheet is conveyed to the folding process conveyance path W2 of the second folding apparatus 1b. As a result, the effect of suppressing a reduction in productivity can be obtained.

Further, in the present embodiment, in a case where sheets are folded alternately by the first folding apparatus 1a and the second folding apparatus 1b, the folded sheets are ejected as follows. That is, a sheet folded by the first folding apparatus 1a is ejected to the ejection tray 100a of the first folding apparatus 1a, and a sheet folded by the second folding apparatus 1b is ejected to the ejection tray 100b of the second folding apparatus 1b. This is because, as will be described below, if the sheets folded by the folding apparatuses are ejected to, for example, a finisher tray of the post-processing apparatus, there is a possibility that productivity may be reduced.

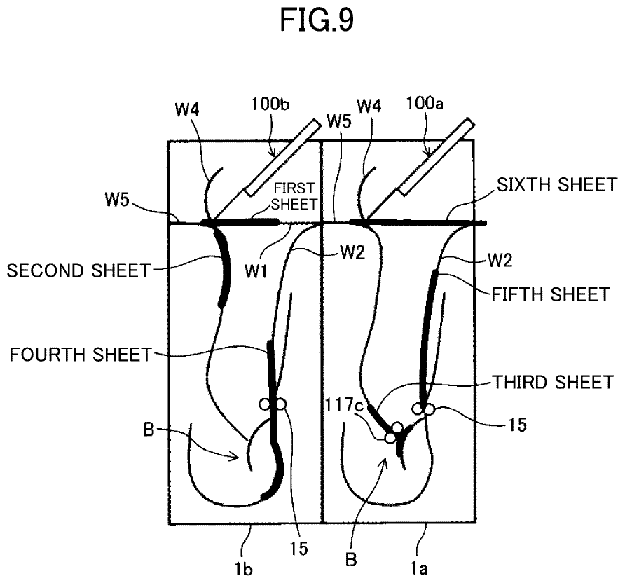

More specifically, if the sheets folded by the folding apparatuses 1a and 1b are ejected to a finisher tray of the post-processing apparatus, the sheet folded by the first folding apparatus 1a is conveyed to the post-processing apparatus 2 as follows. That is, the sheet folded by the first folding apparatus 1a passes through the second ejection path W5 of the folding apparatus 1a, the through conveyance path W1 of the second folding apparatus 1b, the branch portion between the first ejection path W4 and the second ejection path W5 of the second folding apparatus 1b, and is then conveyed to the post-processing apparatus 2. In such a case, as illustrated in FIG. 9, there is a possibility that the leading end of the sheet folded by the second folding apparatus 1b may reach the branch portion between the first ejection path W4 and the second ejection path W5 of the second folding apparatus 1b before the trailing end of the sheet folded by the first folding apparatus 1a passes through this branch portion. As a result, the sheet folded by the second folding apparatus 1b would collide with the sheet folded by the first folding apparatus 1a, and a jam would occur. In order to prevent such collision, it is necessary to reduce the conveying speed of the sheet that has passed through the folding section B of the second folding apparatus 1b or reduce the conveying speed of the sheet folded by the first folding apparatus 1a. As a result, productivity would be reduced.

Conversely, in the present embodiment, as illustrated in FIG. 7D, the sheet folded by the first folding apparatus 1a is ejected to the ejection tray 100a of the first folding apparatus 1a, and the sheet folded by the second folding apparatus 1b is ejected to the ejection tray 100b of the second folding apparatus 1b. With this configuration, the following advantages can be obtained. That is, the sheet folded by the first folding apparatus 1a is not conveyed to the branch portion between the first ejection path W4 and the second ejection path W5 of the second folding apparatus 1b. Therefore, the sheet folded by the first folding apparatus 1a and the sheet folded by the second folding apparatus 1b do not collide with each other at this branch portion. Accordingly, it is not necessary to reduce the conveying speed of the sheet that has passed through the folding section B or reduce the conveying speed of the sheet folded by the first folding apparatus 1a, and productivity will not be reduced.

In this manner, sheets are folded alternately by the two folding apparatuses 1a and 1b and the sheets are ejected to the corresponding ejection trays of the folding apparatuses 1a and 1b. Thus, high producibility can be achieved. However, there may be cases where users do not require high productivity and do not wish to eject sheets to different ejection trays. Therefore, in the present embodiment, a productivity mode is provided. In a case where the productivity mode is selected by a user performing an input operation on the operation panel 1310, sheets are fold alternately by the two folding apparatuses 1a and 1b, the folded sheets are ejected to the corresponding ejection trays of the folding apparatuses 1a and 1b.

In a case where the productivity mode is not selected by the user and single-sheet folding is performed on all sheets in continuous printing, either the first folding apparatus 1a or the second folding apparatus 1b is used to perform the folding process. Then, the folded sheets are ejected to an ejection tray specified by the user (an ejection tray of a folding apparatus that has performed the folding process or a finisher tray of the post-processing apparatus).

Note that even in a case where the productivity mode is not selected by the user and single-sheet folding is performed on all sheets in continuous printing, the first folding apparatus 1a and the second folding apparatus 1b may alternately perform the folding process and eject the sheets folded by the first folding apparatus 1a and the second folding apparatus 1b to an ejection tray specified by the user. In this manner, as compared to when either the first folding apparatus 1a or second folding apparatus 1b is used to perform the folding process, productivity can be improved.

However, if the folding process are alternately performed by the first folding apparatus 1a and the second folding apparatus 1b without the productivity mode being selected, there would be a possibility that a jam would occur. That is, as described with reference to FIG. 9, there would be a possibility that a sheet folded by the second folding apparatus 1b would collide with a sheet folded by the first folding apparatus 1a at the branch portion between the first ejection path W4 and the second ejection path W5 of the second folding apparatus 1b, and a jam would occur. In such a case, it is necessary to perform conveyance control such that the sheet folded by the first folding apparatus 1a and the sheet folded by the second folding apparatus 1b do not collide with each other at the branch portion, and such control may become complicated. Conversely, when the productivity mode is not selected, conveyance control can be simplified by using either the first folding apparatus 1a or the second folding apparatus 1b to perform the folding process.

In the productivity mode, sheets folded by the first folding apparatus 1a are ejected to the ejection tray 100a of the first folding apparatus 1a, and sheets folded by the second folding apparatus 1b are ejected to the ejection tray 100b of the second folding apparatus 1b. Thus, in the related art, there is a problem in that in a case where a plurality of copies of images of a plurality of pages are printed, a plurality of sheets constituting one printed material are ejected to different ejection trays. As a result, after a printing operation is completed, sheets ejected to one ejection tray and sheets ejected to the other ejection tray need to be combined to obtain the printed material, and thus, sorting work of sorting printed materials may be complicated.

More specifically, in a typical image forming apparatus 3, in a case where a plurality of copies of images made up of a plurality of pages are printed, printing is generally performed in units of copies. If a folding apparatus is not connected to the image forming apparatus and the image forming apparatus is used alone, all sheets on which images are formed are ejected to one ejection tray of the image forming apparatus. By performing in units of copies, the first copy serving as a printed material, the second copy serving as a printed material . . . are stacked in this order on the ejection tray of the image forming apparatus, and thus, subsequent sorting work of sorting the printed materials can be simplified.

In an example of related-art productivity mode, in a case where two copies of images made up of three pages are printed by single-sided printing in units of copies, the first page of the first copy (a sheet on which an image of the first page of the first copy is formed), the third page of the first copy (a sheet on which an image of the third page of the first copy is formed), and the second page of the second copy (a sheet on which an image of the second page of the second copy is formed) are odd-numbered sheets. In this example, the first folding apparatus 1a performs the folding process on these pages, and the pages are ejected to the ejection tray 100a of the first folding apparatus 1a. Further, the second page of the first copy (a sheet on which an image of the second page of the first copy is formed), the first page of the second copy (a sheet on which an image the first page of the second copy is formed), and the third page of the second copy (a sheet on which an image of the third page of the second copy is formed) are even-numbered sheets. The second folding apparatus 1b performs the folding process on these pages, and the pages are ejected to the ejection tray 100b of the second folding apparatus 1b.

In the above example of related-art productivity mode, the first page and the third page of the first copy are ejected to the ejection tray 100a of the first folding apparatus 1a, and the second page of the first copy is ejected to the ejection tray 100b of the second folding apparatus 1b. That is, sheets constituting the first copy are separately ejected to the two different ejection trays. Further, the first page and the third page of the second copy are ejected to the ejection tray 100b of the second folding apparatus 1b, and the second page of the second copy is ejected to the ejection tray 100a of the first folding apparatus 1a. Thus, sheets constituting the second copy are separately ejected to the two different ejection trays.

As a result, in subsequent sorting work of sorting printed materials, the second page of the second copy of the sheet bundle ejected to the ejection tray 100a of the first folding apparatus 1a needs to be replaced with the second page of the first copy of the sheet bundle ejected to the ejection tray 100b of the second folding apparatus 1b in order to obtain the printed materials. In such a case, the sorting work of sorting the printed materials would be complicated.

Further, there is also an image forming apparatus that can switch from printing in units of copies to what is known as printing in units of pages in which copies are printed in order of pages (in order of the first page of the first copy→the first page of the second copy→the first page of the third copy→the second page of the first copy . . . ). However, even if copies are printed in units of pages, a plurality of sheets constituting each of the copies would be separately ejected to the two different ejection trays 100a and 100b depending on the number of copies.

For example, if three copies of images of three pages are printed by single-sided printing in units of pages, the first page of the first copy, the first page of the third copy, the second page of the second copy, the third page of the first copy, and the third page of the third copy are ejected to the ejection tray 100a of the first folding apparatus 1a. The first page of the second copy, the second page of the first copy, the second page of the third copy, and the third page of the second copy are ejected to the ejection tray 100b of the second folding apparatus 1b. As described above, even if copies are printed in units of pages, sheets constituting each of the copies would be separately ejected to different ejection trays depending on the number of copies.

As described above, in the above example of related-art productivity mode, pages of a printed material are separately ejected to different ejection trays of folding apparatuses. In such a case, after a printing operation is completed, there would be a need to take out bundles of sheets from the ejection trays of the folding apparatuses and replace some sheets in order to obtain printed materials. Thus, sorting work of sorting the printed materials would be complicated. In view of this, according to the present embodiment, if the productivity mode is set when a plurality of copies of images of a plurality of pages are printed, the printing order is changed such that sheets constituting each of the copies are not ejected to the different ejection trays of the folding apparatuses.

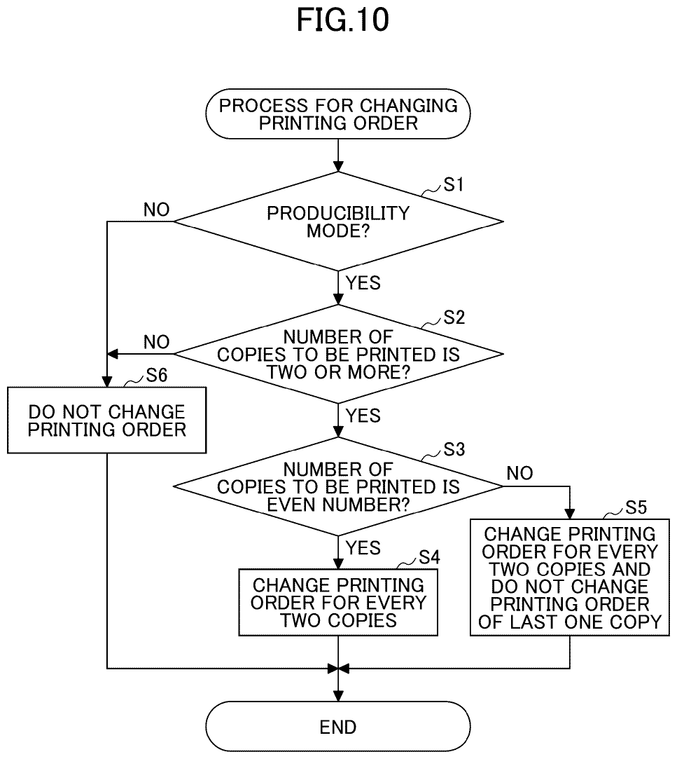

FIG. 10 is a control flowchart of a process for changing the printing order according to the present embodiment. As illustrated in FIG. 10, if the producibility mode is not set (NO in S1) or if the number of copies is one (NO in S2), sheets are folded by one of the folding apparatuses, and all the folded sheets are ejected to an ejection tray specified by the user. Therefore, a plurality of sheets constituting a printed material are not separately ejected to different ejection trays. Thus, the printing order is not changed, and printing is performed by units of copies (S6).

Conversely, if the productivity mode is set (YES in S1), the number of copies to be printed is two or more (YES in S2), and the number of copies to be printed is an even number (YES in S3), the printing order is changed for every two copies (S4). More specifically, the printing order is changed for every two copies from printing in units of copies (printing in order of the first page of the first copy, the second page of the first copy . . . ) to printing in units of pages (printing in order of the first page of the first copy, the first page of the second copy, the second page of the first copy . . . ).

Conversely, if the number of copies to be printed is an odd number (NO in S3), the printing order is changed for every two copies from printing in units of copies to printing in units of pages, and the printing order of the last copy is not changed and the last copy is printed in units of copies (S5).

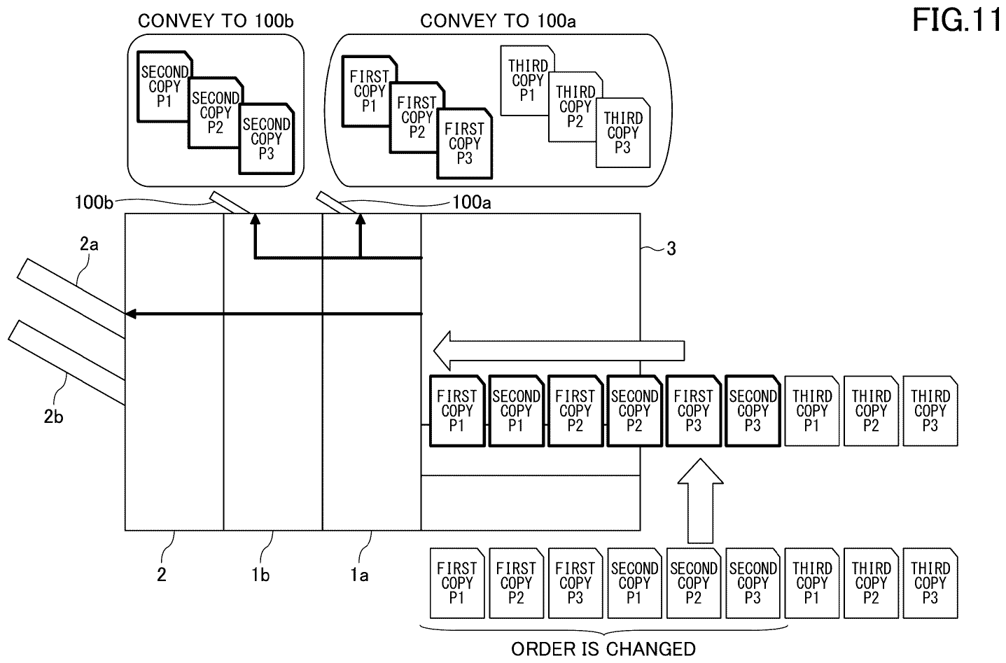

As illustrated in FIG. 11, if three copies of images of three page are printed, the printing order of the first copay and the second copy is changed from printing in units of copies to printing in units of pages. Specifically, the printing order is changed from “the first page of the first copy→the second page of the first copy→the third page of the first copy” to “the first page of the first copy→the first page of the second copy→the second page of the first copy→the second page of the second copy”. For the third copy, which is the last copy, the printing order is not changed, and the order of the “first page of the third copy→the second page of the third copy→the third page of the third copy” is maintained.

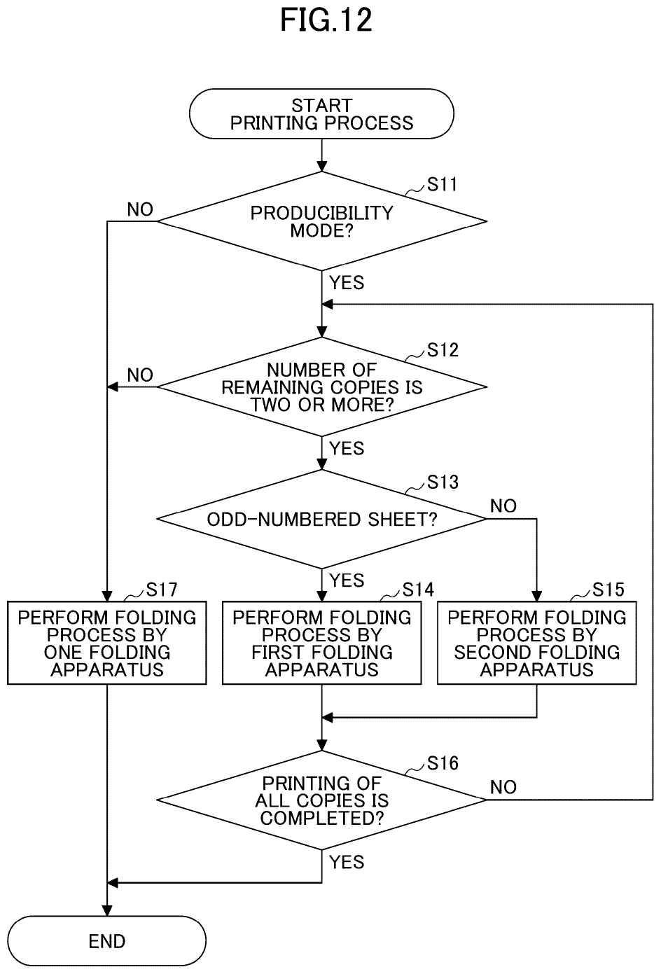

Upon completion of the process for changing the printing order, a printing process is started. FIG. 12 is a control flowchart of sheet conveyance during a printing process. If a setting for performing single-sheet folding on all sheets is selected and the producibility mode is not set (NO in S11), the folding process is performed by either one of the two folding apparatuses (S17). Then, the folded sheets are ejected to an ejection tray specified by the user.

In this manner, if the productivity mode is not set, all the folded sheets are stacked in the printing order on the one ejection tray specified by the user. As illustrated in FIG. 10, if the productivity mode is not set, printing is performed in units of copies (in order of the first page of the first copy, the second page of the first copy, the third page of the first copy, the first page of the second copy . . . ) without changing the printing order. As a result, the first copy serving as a printed material, the second copy serving as a printed material . . . are stacked in this order on the ejection tray specified by the user. Accordingly, subsequent sorting work for sorting the printed materials can be easily performed.

Conversely, if the productivity mode is set (YES in S11), the controller 1300 determines whether the number of remaining copies that have not been printed is two or more (S12).

If the number of remaining copies is two or more (YES in S12), and a sheet ejected from the image forming apparatus 3 is an odd-numbered sheet (YES in S13), the sheet is conveyed to the folding process conveyance path W2 of the first folding apparatus 1a. Then, the first folding apparatus 1a performs the folding process on the sheet (S14), and the folded sheet is ejected to the ejection tray 100a of the first folding apparatus 1a.

Conversely, a sheet ejected from the image forming apparatus 3 is an even-numbered sheet (NO in S13), the sheet is conveyed to the folding process conveyance path W2 of the second folding apparatus 1b. Then, the second folding apparatus 1b performs the folding process on the sheet (S15), and the folded sheet is ejected to the ejection tray 100b of the second folding apparatus 1b.

In the process for changing the printing order illustrated in FIG. 10, changing the printing order for every two copies from printing in units of copies to printing in units of pages, sheets of an odd-numbered copy are conveyed as odd-numbered sheets and sheets of an even-numbered copy are conveyed as even-numbered sheets.

In the example illustrated in FIG. 11, by performing the process for changing the printing order, the first page of the first copy, the second page of the first copy, and the third page of the first copy are conveyed as odd-numbered sheets, folded sequentially by the first folding apparatus 1a, and ejected sequentially to the ejection tray 100a of the first folding apparatus 1a. In this manner, the first copy serving as a printed material is ejected to the ejection tray 100a of the first folding apparatus 1a. Further, by performing the process for changing the printing order, the first page of the second copy, the second page of the second copy, and the third page of the second copy are conveyed as even-numbered sheets, folded sequentially by the second folding apparatus 1b, and ejected sequentially to the ejection tray 100b of the second folding apparatus 1b. In this manner, the second copy serving as a printed material is ejected to the ejection tray 100b of the second folding apparatus 1b.

if printing of all copies is not completed (NO in S16), the controller 1300 causes the process to return to step S12, and continues the process. In the example illustrated in FIG. 11, printing of the last one copy is not completed. Thus, the controller 1300 causes the process to return to step S12 and continues the process.

In step S12, if the number of remaining copies is 1 (NO in S12), either the first folding apparatus 1a or the second folding apparatus 1b performs the folding process on the remaining one copy (S17). Then, the folded sheet is ejected to an ejection tray of a folding apparatus that has performed the folding process.

In the example of FIG. 11, the sheets of the third copy on which the images are formed are folded by the first folding apparatus 1a, and are ejected to the ejection tray 100a of the first folding apparatus 1a. As illustrated in FIG. 11, the printing order of the third copy, which is the last copy, is not changed by the process for changing the printing order illustrated in FIG. 10, and printing in units of copies is maintained. Therefore, for the third copy, which is the last copy, printing is performed in order of the first page of the third copy, the second page of the third copy, and the third page of the third copy. Therefore, the folded sheets of the third copy are ejected to the ejection tray 100a of the first folding apparatus 1a in order of pages, and the third copy serving as a printed material is stacked on the ejection tray 100a.

In the example illustrated in FIG. 11, the first copy and the third copy serving as the printed materials (odd-numbered printed materials) are stacked on the ejection tray 100a of the first folding apparatus 1a, and the second copy serving as the printed material is stacked on the ejection tray 100b of the second folding apparatus 1b.

As described, in the present embodiment, in a case where a plurality of copies of images of plurality of pages are printed in the productivity mode, the printing order is changed such that every two copies are printed in units of pages and the remaining one copy is printed in units of copies. If the number of remaining copies is two or more, a folding apparatus that performs the folding process is switched for each sheet, and if the number of remaining copies is one, the folding process performed by one of the fold apparatuses. Accordingly, copies are stacked in the form of printed materials in order of pages in each of the folding apparatuses. Thus, after a printing operation is completed, sorting work of sorting the printed materials can be easily performed.

In the above description, in the productivity mode, sheets folded by the first folding apparatus 1a are ejected to the ejection tray 100a of the first folding apparatus 1a, and sheets folded by the second folding apparatus 1b are ejected to the ejection tray 100b of the second folding apparatus 1b. However, for example, the sheets may be ejected as follows. That is, sheets folded by the first folding apparatus 1a may be ejected to the ejection tray 100a of the first folding apparatus 1a, and sheets folded by the second folding apparatus 1b may be conveyed to the post-processing apparatus 2 and ejected to either the finisher tray 2a or the finisher tray 2b. Even when the sheets folded by each of the folding apparatuses are ejected in this manner, a sheet folded by the first folding apparatus does not collide with a sheet folded by the second folding apparatus, as in the case of FIG. 9. Note that ejecting the sheets folded by the second folding apparatus 1b to the ejection tray 100b of the second folding apparatus 1b is preferable because the sheet conveyance path can be shortened and the operation period can be shortened accordingly, as compared to when the sheets are ejected to the one of the finisher trays of the post-processing apparatus 2.

Although specific embodiments of the present invention has been described, the present invention is not limited to these embodiments, and various modifications and changes may be made without departing from the scope of the present invention. For example, three or more folding apparatuses may be connected. In this case, the printing order is changed as follows. That is, each number of copies that is the same as the number of connected folding apparatuses is printed in units of pages (instead of in units of copies). If the number of remaining copies is one, the remaining one copy is printed in units of copies. If the number of remaining copies is plural (two or more and less than the number of connected folding apparatuses), the remaining copies are printed in units of pages (instead of in units of copies).

In sheet conveyance control when the productivity mode is set, if the number of remaining copies is greater than or equal to the number of a plurality of connected folding apparatuses, sheets are sequentially conveyed to a plurality of folding apparatuses. Then, each of the folding apparatuses performs the folding process on sheets, and the sheets are ejected to a corresponding ejection tray of each of the folding apparatuses. If the number of remaining copies is one, one folding apparatus of the plurality of folding apparatuses performs the folding process on sheets, and the sheets are ejected to an ejection tray of the one folding apparatus that has performed the folding process, as described in S17 of FIG. 12. Conversely, if there are a plurality of remaining copies (the number of remaining copies are two or more and less than the number of connected folding apparatuses), folding apparatuses that are of the same number as the number of remaining copies are used to perform the folding process on sheets, and the sheets are ejected to corresponding ejection trays of the folding apparatuses that have performed the folding process. Accordingly, when three or more folding apparatuses are connected, productivity can be improved and a printed material can be stacked in order of pages on an ejection tray of each of the folding apparatuses.

The above description is an example and has a specific effect for each of the following aspects.

(First aspect) 1. An image forming system includes an image forming apparatus 3 configured to print images on a plurality of sheets; a plurality of folding apparatuses (a first folding apparatus 1a and a second folding apparatus 1b in an embodiment) configured to perform a folding process on the plurality of sheets; a memory; and a processor coupled to the memory and configured to switch between the plurality of folding apparatuses for each of the plurality of sheets such that the folding process is performed on the plurality of sheets in continuous printing, and eject one or more sheets on which the folding process is performed by each of the plurality of folding apparatuses to a corresponding ejection tray, wherein an order of the images to be printed on the plurality of sheets in the continuous printing is changeable.

Although Patent Document 1 does not describe the order of printing in a case where a plurality of copies of images of a plurality of pages are printed, printing is generally performed in units of copies (in order of all pages of the first copy→all pages of the second copy . . . ). If a folding apparatus is not connected to an image forming apparatus and the image forming apparatus is used alone, all sheets on which the images are formed are ejected to one ejection tray of the image forming apparatus. This is because, by performing printing in units of copies, sheets of the first copy and sheets of the second copy are stacked in this order on the ejection tray of the image forming apparatus, and subsequent sorting work of sorting the printed materials is simplified. In Patent Document 1, in a case where a plurality of copies of images of a plurality of pages are printed in a unit of copies, a folding process is performed while switching between two folding apparatuses for each of the sheets, and the folded sheets are ejected to ejection trays serving as folded sheet storage boxes provided below the respective folding apparatuses. That is, for example, in a case where two copies of images of three pages are printed by single-sided printing and continuous printing is performed in units of copies, a sheet on which an image of the first page of the first copy is formed, a sheet on which an image of the third page of the first copy is formed, and a sheet on which an image of the second page of the second copy is formed are conveyed as odd-numbered sheets and are ejected to an ejection tray of a folding apparatus on the downstream side in the ejection direction. Further, a sheet on which an image of the second page of the first copy is formed, a sheet on which an image of the first page of the second copy is formed, and a sheet on which an image of the third page of the second copy is formed are conveyed as even-numbered sheets and are ejected to an ejection tray of a folding apparatus on the upstream side in the ejection direction. In this manner, the first page and the third page of the first copy are ejected to the ejection tray of the folding apparatus on the downstream side in the ejection direction, and the second page of the first copy is ejected to the ejection tray of the folding apparatus on the upstream side in the ejection direction. Thus, the sheets of the first copy are separately ejected to the two different ejection trays. Further, the first page and the third page of the second copy are ejected to the ejection tray of the folding apparatus on the upstream side in the ejection direction, and the second page of the second copy is ejected to the ejection tray of the folding apparatus on the downstream side in the ejection direction. Thus, the sheets of the second copy are separately ejected to the two different ejection trays. As a result, the sheet on which the second page of the second copy is formed, among the bundle of sheets ejected to the ejection tray of the folding apparatus on the downstream side, needs to be replaced with the sheet on which the second page of the first copy is formed, among the bundle of sheets ejected to the ejection tray of the folding apparatus on the upstream side, in order to obtain printed materials. In such a case, sorting work of sorting the printed materials would be complicated. Conversely, according to the first aspect, the order of images to be printed can be changed in continuous printing. Thus, in a case where a plurality of copies of images of a plurality of pages are printed, the printing order can be changed so as not to separately eject sheets constituting each of the copies to the different ejection trays of the folding apparatuses. That is, in a case where two copies of images of three pages are printed by single-sided printing as in the above case, the printing order is changed such that printing is performed in order of the first page of the first copy→the first page of the second copy→the second page of the first copy→the second page of the second copy→the third page of the first copy→the third page of the second copy. Thus, a sheet on which an image of the first page of the first copy is formed, a sheet on which an image of the second page of the first copy is formed, and a sheet on which an image of the third page of the first copy are conveyed as odd-numbered sheets. In addition, a sheet on which an image of the first page of the second copy is formed, a sheet on which an image of the second page of the second copy is formed, and a sheet on which an image of the third page of the second copy is formed are conveyed as even-numbered sheets. Accordingly, in a case where the folding process is alternately performed by switching between the two folding apparatuses for each of sheets, all sheets constituting the first copy are ejected to an ejection tray of one of the folding apparatuses, and all sheets constituting the second copy are ejected to an ejection tray of the other of the folding apparatuses. According to the first aspect, in a case where a plurality of copies of images of a plurality of pages are printed, sheets constituting a printed material of each of the copies can be prevented from being separately ejected to the different ejection trays of the folding apparatuses. Thus, subsequent sorting work of sorting printed materials can be simplified.

(Second aspect) In the first aspect, the plurality of folding apparatuses 1a and 1b include respective ejection trays 100a and 100b to which sheets on which the folding process is performed are ejected, and in a case where a plurality of copies of images of a plurality of pages are to be printed, the processor is configured to change an order of the images to be printed such that the plurality of copies are ejected to an ejection tray of the each of the plurality of folding apparatuses in units of copies. Accordingly, each of the plurality of copies can be ejected to the ejection tray of each of the folding apparatuses in the form of a printed material. Thus, sorting work of sorting printed materials can be simplified.

(Third aspect) In the second aspect, the processor is configured to change the order of the images to be printed such that each number of copies that is same as a number of the folding apparatuses (two folding apparatuses in the embodiment) is printed in units of pages. Accordingly, as described in the above embodiment, each of the plurality of copies can be ejected to the ejection tray of each of the folding apparatuses in the form of a printed material. Thus, sorting work of sorting printed materials can be simplified.

(Fourth aspect) In the third aspect, the processor is configured to use one folding apparatus of the plurality of folding apparatuses to perform the folding process in a case where a remaining number of copies to be printed is one. Accordingly, as described in the above embodiment, the remaining one copy can be ejected to the ejection tray of each of the folding apparatuses in the form of a printed material.

(Fifth Aspect) In any of the first to fourth aspects, the plurality of folding apparatuses include ejection trays to which the plurality of sheets on which the folding process is performed are ejected, in a case where the folding process is performed on the plurality of sheets while switching between the plurality of folding apparatuses for each of the plurality of sheets in the continuous printing, the processor is configured to eject one or more sheets to an ejection tray of a folding apparatus that has performed the folding process, and the processor is configured to allow, in the continuous printing, a user to select whether to perform the folding process on the plurality of sheets while switching between the plurality of folding apparatuses for each of the plurality of sheets or whether to perform the folding process on the plurality of sheets by using one folding apparatus of the plurality of folding apparatuses. Accordingly, if the user places importance on productivity, the user can select the productivity mode such that the folding process is performed on the plurality of sheets while switching between the plurality of folding apparatuses for each of the plurality of sheets. If the user wishes to eject all the folded sheets to one ejection tray, the user can choose not to select the productivity mode.

According to one embodiment of the present disclosure, in a case where a plurality of copies of an image of a plurality of pages are printed, sorting work of soring printed materials after a printing operation is completed can be simplified.

What is claimed is:

1. An image forming system comprising:
an image forming apparatus configured to print images on a plurality of sheets;
a plurality of folding apparatuses configured to perform a folding process on the plurality of sheets;
a memory; and
a processor coupled to the memory and configured to
switch between the plurality of folding apparatuses for each of the plurality of sheets such that the folding process is performed on the plurality of sheets in continuous printing, and eject one or more sheets on which the folding process is performed by each of the plurality of folding apparatuses to a corresponding ejection tray,
wherein an order of the images to be printed on the plurality of sheets in the continuous printing is changeable.

2. The image forming system according to claim 1, wherein
each of the plurality of folding apparatuses includes an ejection tray to which a sheet on which the folding process is performed is ejected, and
in a case where a plurality of copies of images of a plurality of pages are to be printed, the processor is configured to change an order of the images to be printed such that the plurality of copies are ejected to the ejection tray of the each of the plurality of folding apparatuses in units of copies.

3. The image forming system according to claim 2, wherein the processor is configured to change the order of the images to be printed such that each number of copies that is same as a number of the folding apparatuses is printed in units of pages.

4. The image forming system according to claim 3, wherein the processor is configured to use one folding apparatus of the plurality of folding apparatuses to perform the folding process in a case where a remaining number of copies to be printed is one.

5. The image forming system according to claim 1, wherein
the plurality of folding apparatuses include ejection trays to which the plurality of sheets on which the folding process is performed are ejected,
in a case where the folding process is performed on the plurality of sheets while switching between the plurality of folding apparatuses for each of the plurality of sheets in the continuous printing, the processor is configured to eject one or more sheets to an ejection tray of a folding apparatus that has performed the folding process, and
the processor is configured to allow, in the continuous printing, a user to select whether to perform the folding process on the plurality of sheets while switching between the plurality of folding apparatuses for each of the plurality of sheets or whether to perform the folding process on the plurality of sheets by using one folding apparatus of the plurality of folding apparatuses.

6. An image forming method performed by an image forming system including
an image forming apparatus configured to print images on a plurality of sheets, and
a plurality of folding apparatuses configured to perform a folding process on the plurality of sheets; the image forming method comprising:
switching between the plurality of folding apparatuses for each of the plurality of sheets such that the folding process is performed on the plurality of sheets in continuous printing; and
ejecting one or more sheets on which the folding process is performed by each of the plurality of folding apparatuses to a corresponding ejection tray,
wherein an order of the images to be printed on the plurality of sheets in the continuous printing is changeable.

7. The image forming method according to claim 6, wherein each of the plurality of folding apparatuses includes an ejection tray to which a sheet on which the folding process is performed is ejected, the method further comprising:
in a case where a plurality of copies of images of a plurality of pages are to be printed, changing an order of the images to be printed such that the plurality of copies are ejected to the ejection tray of the each of the plurality of folding apparatuses in units of copies.

8. The image forming method according to claim 7, further comprising:
changing the order of the images to be printed such that each number of copies that is same as a number of the folding apparatuses is printed in units of pages.

9. The image forming method according to claim 8, further comprising:
using one folding apparatus of the plurality of folding apparatuses to perform the folding process in a case where a remaining number of copies to be printed is one.

10. The image forming method according to claim 6, wherein the plurality of folding apparatuses include ejection trays to which the plurality of sheets on which the folding process is performed are ejected, the method further comprising:
in a case where the folding process is performed on the plurality of sheets while switching between the plurality of folding apparatuses for each of the plurality of sheets in the continuous printing, ejecting one or more sheets to an ejection tray of a folding apparatus that has performed the folding process, and
allowing, in the continuous printing, a user to select whether to perform the folding process on the plurality of sheets while switching between the plurality of folding apparatuses for each of the plurality of sheets or whether to perform the folding process on the plurality of sheets by using one folding apparatus of the plurality of folding apparatuses.
